(19) United States
(12) Patent Application Publication
(10) Pub. No.: US 2015/0067363 A1
(43) Pub. Date: Mar. 5, 2015

(54) CLOCK GENERATOR CIRCUIT WITH AUTOMATIC SLEEP MODE

(71) Applicants: Sebastien JOUIN, Nantes (FR); Patrice MENARD, Nantes (FR); Thierry GOURBILLEAU, Nantes (FR); Estelle FAZILLEAU, Nantes (FR)

(72) Inventors: Sebastien JOUIN, Nantes (FR); Patrice MENARD, Nantes (FR); Thierry GOURBILLEAU, Nantes (FR); Estelle FAZILLEAU, Nantes (FR)

(21) Appl. No.: 14/018,263

(22) Filed: Sep. 4, 2013

(51) Int. Cl. G06F 1/32; G06F 1/06

(52) U.S. Cl. CPC G06F 1/3234; G06F 1/06
USPC 713/320

(57) ABSTRACT

A clock generator circuit for an integrated circuit (IC) component (e.g., a microcontroller unit) is disclosed that provides an automatic sleep mode for modules of the IC component. In some implementations, the clock generator circuit provides a simplified user interface and low power consumption by implementing one sleep mode level and allowing modules in the IC to start and stop internal clocks dynamically on demand. In active mode, the power consumption can be reduced to a minimum by turning off clocks for unused modules.

### TECHNICAL FIELD

This disclosure relates generally to clock generation circuits for low power integrated circuits (e.g., low power microcontroller units).

### BACKGROUND

A clock generator circuit produces one or more clock signals (also referred to as “clocks”) for use in synchronizing the operation of modules of an integrated circuit component. A clock signal can be, for example, a symmetrical square wave. A conventional clock generator includes a resonant circuit and an amplifier. The resonant circuit may be a quartz piezo-electric oscillator, a tank circuit or a Resistor-Capacitor (RC) circuit. The amplifier inverts the signal from the oscillator then feeds a portion back into the oscillator to maintain oscillation. The clock generator may include a frequency divider or clock multiplier, which can be programmed to allow a variety of output frequencies to be selected without modifying hardware.

In low power microcontrollers that use conventional clock generator circuits, a number of sleep modes may be implemented to stop individually the clock for each module using clock mask registers. Multiple levels of sleep modes are implemented to provide the user the capability to choose an exact sleep mode according to application requirements to reduce power consumption.

From a design perspective, this solution is complex because a tradeoff is made between too many and too few sleep mode levels. Having many sleep mode levels allows a user to choose a good sleep mode level according to an application at a price of increased complexity of the user interface, which explains how the sleep mode levels work. Having few sleep mode levels results in a simplified user interface at the price of increased power consumption. For example, a module may still be clocked even when the module is not being used by the application.

### SUMMARY

A clock generator circuit for an integrated circuit (IC) component (e.g., a microcontroller unit) is disclosed that provides an automatic sleep mode for modules of the IC component. In some implementations, the clock generator circuit provides a simplified user interface and low power consumption by implementing one sleep mode level and allowing modules in the IC to start and stop internal clocks dynamically on demand. In active mode, the power consumption can be reduced to a minimum by turning off clocks for unused modules.

In some implementations, a method performed by an integrated circuit (IC) component comprises: providing a first clock to a module in the IC component in response to a clock request from the module, where the first clock is provided by a clock source in the IC component; providing a second clock to a processing unit in the IC component, where the second clock is provided by the clock source according to a sleep mode signal; receiving a request to transition the IC component into sleep mode, where the request is independent of the clock request; and transitioning the IC component into sleep mode according to the sleep mode signal while providing the first clock to the module in response to the clock request.

In some implementations, an integrated circuit (IC) component comprises: a processor unit; a clock source; a module; a controller configured to automatically generate a sleep mode signal; a first clock gate coupled between the clock source and the module, the first clock gate configured to provide a first clock to the module in response to a clock request from the module; and a second clock gate coupled between the clock source and the processor unit, the second clock gate configured to provide a second clock to the processor unit according to the sleep mode signal, where the first clock is provided to the module regardless of the sleep mode signal.

Other implementations are disclosed that are directed to systems and/or devices.

Particular implementations of a clock generator circuit with automatic sleep mode for modules provides one or more of the following advantages: 1) the sleep mode level for an application is automatically adjusted according to module activity (clock demand); 2) the user interface is simplified by providing one sleep mode level to the user; 3) in active mode, the user interface is simplified by removing the clock masking register for each module; and 4) the software is simplified.

### BRIEF DESCRIPTION OF THE DRAWINGS

FIG. 1 is a block diagram of an example clock generator circuit with automatic sleep mode for modules.

FIG. 2 illustrates a flow diagram of an example automatic sleep mode for modules.

### DETAILED DESCRIPTION

Example Clock Generator Circuit With Automatic Sleep Mode For Modules

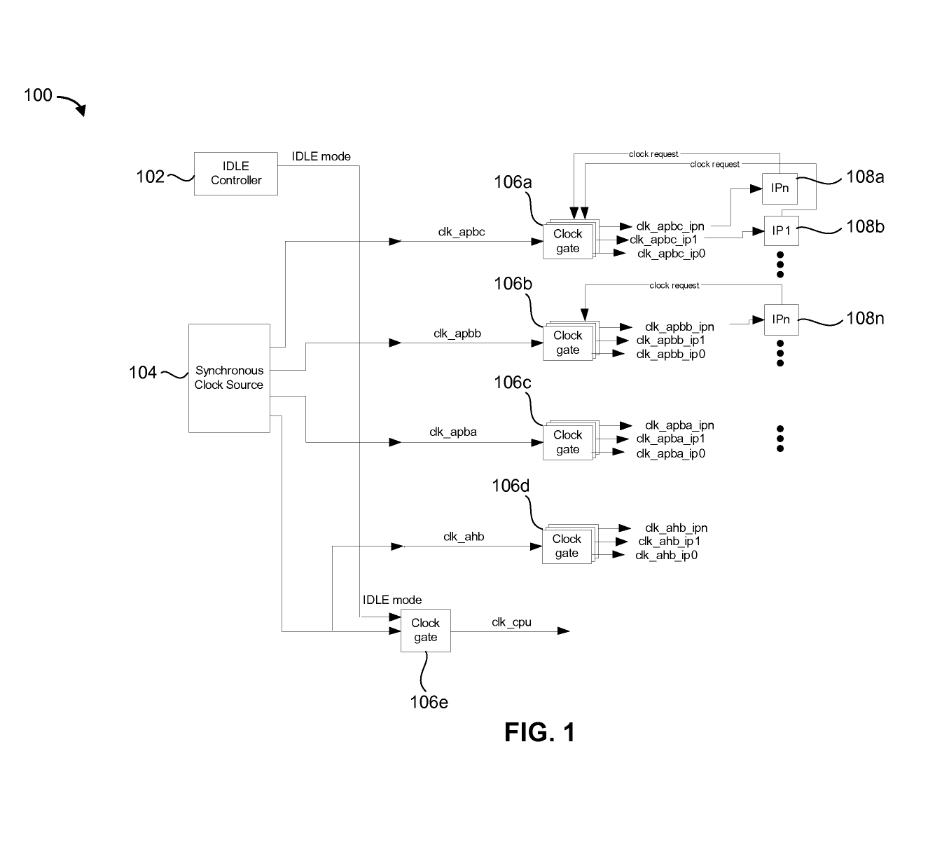

FIG. 1 is a block diagram of an example clock generator circuit 100 with automatic sleep mode for modules. In some implementations, clock generator circuit 100 may include IDLE controller 102, synchronous clock source 104, clock gates 106a-106e and modules 108a-108n (e.g., peripherals). Circuit 100 can be implemented in an IC chip. In the example shown, circuit 100 is implemented in a microcontroller unit that includes a central processing unit (CPU) and modules 108a-108n that require internal clocks to operate. Each module 108a-108n is coupled to one of clock gates 106a-106d. Clock gate 106e is coupled to the CPU (not shown). There can be any desired number of clock gates and modules depending on the application.

Synchronous clock source 104 provides clocks to clock gates 106a-106e. The clocks are designated in FIG. 1 as clk_apbc, clk_apbb, clk_apba and clk_ahb. In some implementations, a clock can be any suitable waveform with a defined duty cycle. For example, a clock can be a symmetrical square wave with a 50% duty cycle. In the configuration shown, clock gates 106d and 106e share clk_ahb. Each of clock gates 106a-106d can provide on demand one or more clocks to one or more modules 108a-108n. For example, clock gate 106a provides clock clk_apbc_ipn to module 108a in response to a clock request from module 108a. Similarly, clock gate 106b provides clock clk_apbc_ip1 to module 108b in response to a clock request from module 108b. In sum, when a clock request generated by a module is active, the clock for the module is commanded ON or OFF by the clock gate according to the activity of the requesting module.

Controller 102 provides a sleep mode signal (IDLE mode) to clock gate 106e, which provides a clock to the CPU. The sleep mode signal transitions the CPU in sleep by commanding clock clk_cpu OFF using clock gate 106e (e.g. am AND gate). In some implementations, controller 102 can be programmed by software according to a desired application.

Clock source 104 continues to run as long as at least one module is requesting clock source 104. Having clock source 104 continuously run even if there is no demand from modules will waste power. Depending on the application, clock source 104 maybe switched off entirely (rather than gated) when clock source 104 is not requested by any modules to reduce further power consumption.

Clock generator circuit 100 provides several advantages over convention clock generator circuits. For example, clock generator circuit 100 provides one level of sleep mode while also reducing power consumption. In active mode (CPU running), power consumption can be further reduced by turning off clocks for unused modules. Circuit 100 automatically adjusts the level of sleep mode according to module activity without using clock mask registers. For example, each of modules 108a-108n is running or not (clocked or not) independently of a global sleep mode state controlled by IDLE controller 102. The activities of modules 108a-108n are not affected by the global sleep mode. Rather, each of modules 108a-108n is automatically set to a local sleep mode according to its respective local clock request without user intervention.

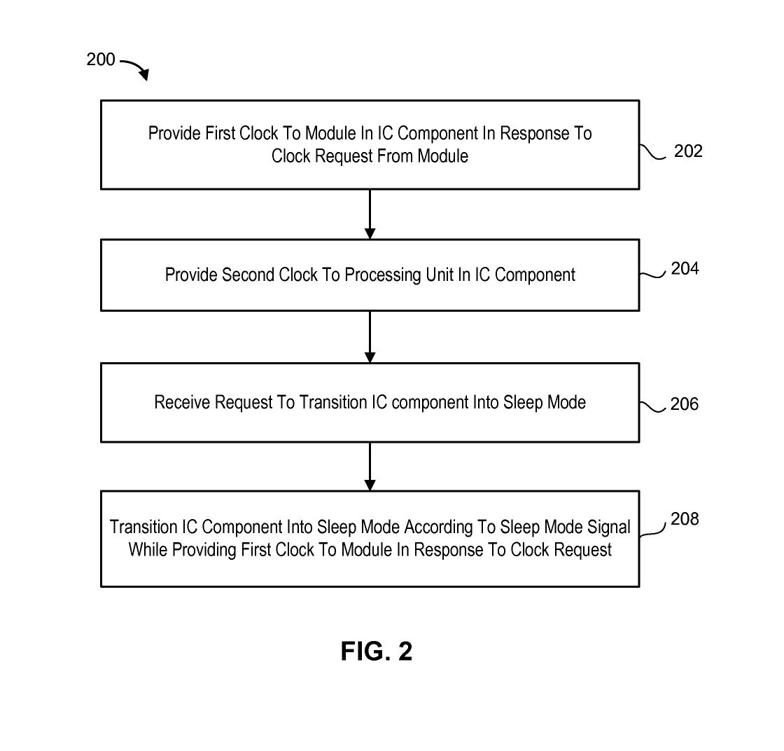

FIG. 2 illustrates a flow diagram of an example automated sleep mode process 200 for modules. Process 200 may be implemented by clock generator circuit 100 described in reference to FIG. 1.

In some implementations, process 200 may begin by providing a first clock to a module in an IC component in response to a clock request from the module (202), where the first clock is provided by a clock source in the IC component. In some implementations, the clock source is a synchronous clock source that provides a symmetrical clock waveform (e.g., square wave) with a predetermined duty cycle (e.g., 50% duty cycle). The IC component can be, for example, a microcontroller unit. The module can be, for example, a peripheral. The first clock can be provided by a first clock gate coupled between the clock source and the module. The module is configured to provide a clock request signal to the first clock gate and the clock gate responds to the request by providing the first clock. The IC component can have any number of modules, and each module can have its own clock gate that can be independently controlled by the module using its clock request signal.

Process 200 can continue by providing a second clock to a processing unit in the IC component (204), where the second clock is provided by the clock source according to a sleep mode signal. The second clock can be provided by a second clock gate. The second clock gate can be coupled to the sleep mode signal using logic (e.g., AND gate) such that the second clock gate provides a second clock to the processor unit when the sleep mode signal indicates that the processor unit is active (not in sleep mode).

Process 200 can continue by receiving a request to transition the IC component into sleep mode (206), where the request is independent of the clock request. The request can be sent by, for example, a programmable controller.

Process 200 can continue by transitioning the IC component into sleep mode according to the sleep mode signal while providing the first clock to the module in response to the clock request (208). Each module can independent of other modules and the processor unit, request a clock signal from its respective clock gate to allow the module to function even when the IC component is in sleep mode.

While this document contains many specific implementation details, these should not be construed as limitations on the scope what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

What is claimed is:

1. A method performed by an integrated circuit (IC) component, the method comprising:
providing a first clock to a module in the IC component in response to a clock request from the module, where the first clock is provided by a clock source in the IC component;
providing a second clock to a processing unit in the IC component, where the second clock is provided by the clock source according to a sleep mode signal;
receiving a request to transition the IC component into sleep mode, where the request is independent of the clock request; and
transitioning the IC component into sleep mode according to the sleep mode signal while providing the first clock to the module in response to the clock request.

2. The method of claim 1, further comprising:
determining that the clock request has been released; and
stopping the first clock.

3. The method of claim 1, further comprising:
determining that no module is requesting the clock source; and
releasing the clock source.

4. An integrated circuit (IC) component including a clock generator circuit, comprising:
a processor unit;
a clock source;
a module;
a controller configured to generate a sleep mode signal;
a first clock gate coupled between the clock source and the module, the first clock gate configured to provide a first clock to the module in response to a clock request from the module; and
a second clock gate coupled between the clock source and the processor unit, the second clock gate configured to provide a second clock to the processor unit according to the sleep mode signal, where the first clock is provided to the module regardless of the sleep mode signal.

5. The clock generator circuit of claim 4, where the clock source is configured to stop if no module is requesting the clock source.

6. The clock generator circuit of claim 4, where the IC component is a microcontroller.

7. The clock generator circuit of claim 4, where the clock source is a synchronous clock source.

8. The clock generator circuit of claim 4, where the first or second clocks are symmetrical clocks having a predetermined duty cycle.

9. The clock generator circuit of claim 4, where the controller is user programmable.

10. A clock generator circuit comprising:
means for providing a first clock to a module in the IC component in response to a clock request from the module, where the first clock is provided by a clock source in the IC component;
means for providing a second clock to a processing unit in the IC component, where the second clock is provided by the clock source according to a sleep mode signal;
means for receiving a request to transition the IC component into sleep mode, where the request is independent of the clock request; and
means for transitioning the processing unit into the sleep mode using the sleep mode signal while providing the first clock to the module in response to the clock request.

11. The circuit of claim 10, further comprising:
means for determining that the clock request has been released; and
means for stopping the first clock.

12. The circuit of claim 10, further comprising:
means for determining that no module is requesting the clock source; and
means for releasing the clock source.
